(19) United States
(12) Patent Application Publication
(10) Pub. No.: US 2020/0320124 A1
(43) Pub. Date: Oct. 8, 2020

(54) METHODS FOR TWO-WAY DATA WRITE BACK IN PRESENTATIONS

(71) Applicant: ACTIVEGRAF, INC., Charlotte, NC (US)

(72) Inventors: Laszlo M Balassy, Charlotte, NC (US); Zsolt Nagy, Budapest (HU)

(21) Appl. No.: 16/769,612

(22) PCT Filed: Dec. 5, 2018
(86) PCT No.: PCT/US2018/064027

§ 371 Date: Jun. 4, 2020

Related U.S. Application Data
(60) Provisional application No. 62/595,550, filed on Dec. 6, 2017.

(51) Int. Cl. G06F 16/904; G06F 16/901; G06F 16/26; G06Q 10/06

(52) U.S. Cl. CPC G06F 16/904; G06Q 10/06393; G06F 16/26; G06F 16/9024

(57) ABSTRACT

Systems and methods for Interactive two-way write back of data flows between visualizations, calculation engines, and data sources are described herein.

### CROSS-REFERENCE TO RELATED APPLICATIONS

This application claims the benefit of U.S. application Ser. No. 62/595,550 filed Dec. 6, 2017.

### FIELD

This disclosure relates to advanced systems and methods for interactive presentation and manipulation of business and economic data.

### BACKGROUND

Presentation software has not evolved with the needs of business users. Even dashboard applications dubbed interactive simply filter and sort data for visualizations but do not allow real time scenario analysis based on changes in assumptions.

Interactive and immersive engagement of one's audience is increasingly fundamental to innovative approaches to most industries and sectors, including consulting, financial services, marketing & advertising, engineering, control functions, and risk functions. These approaches include Lean methodology, consultative sales, building trusted advisor relationships, increasing client share of mind, challenger sales. All are based on building dialogue with the audience and exploring alternative solutions together.

However, the software tools used to deliver >90% of today's business presentations do not support scenario analysis. The remaining 10% are presented in the form of dashboards which are termed interactive, but in reality, are visualizations of static data, with no ability to influence results by providing new assumptions during the given presentation.

The need for being able to flexibly manage assumptions is also driven by the increasingly quantitative requirements of today's business environment. The increased prevalence of data analytics, predictive analytics, and propensity modelling in virtually all sectors necessitates a more flexible and scenario enabled presentation tool. When dealing with calculation intensive subject matter, speed and depth of comprehension is greatly enhanced by sensitivity analysis.

There is a need therefore for new systems and methods that can perform real time synchronization of calculation engines, data sources, and presentation tools. And ideally to add visual, graphic control to the synchronized calculation engine, data source and presentation tools.

### BRIEF SUMMARY

We propose a data, calculation and visualization software hub that allows for interactive two-way write back of data flows between visualizations, calculation engines, and data sources for use in presenting analyses.

### DESCRIPTION OF THE FIGURES

FIG. 1 illustrates the overall system architecture and data flows of the proposed software hub including its linkages to various possible data sources, calculations engines, defined data sources, and presentation tools.

### DETAILED DESCRIPTION

In the following detailed description, reference is made to accompanying drawings that illustrate embodiments of the present disclosure. These embodiments are described in sufficient detail to enable a person of ordinary skill in the art to practice the disclosure without undue experimentation. It should be understood, however, that the embodiments and examples described herein are given by way of illustration only, and not by way of limitation. Various substitutions, modifications, additions, and rearrangements may be made without departing from the spirit of the present disclosure. Therefore, the description that follows is not to be taken in a limited sense, and the scope of the present disclosure will be defined only by the final claims.

Most well-structured presentations introduce a given solution or set of solutions by first establishing key assumptions. Traditional presentations require setting these assumptions before the meeting, often extrapolated from limited and stale information. It is a common occurrence for the audience to provide materially different scenarios than those which have been prepared. Currently, there are generally three responses to changes in assumptions, none of which are optimal:
1. The presentation is cut short, information is exchanged, and there is an attempt to reschedule the meeting to present revised analysis based on the revised assumptions. Typically, this rescheduling disrupts the flow and momentum of the dialogue with the audience, misses an opportunity for consultative discussion, and very often results in a follow up meeting that is weeks if not months after the original.
2. The presenter(s) labor through the existing presentation trying to cover the stated differences with on the fly analysis and estimates of results based on the new parameters. This solution holds many risks. First, it puts a tremendous amount of pressure on the presenters to get it right thinking on their feet, in addition to trying to achieve the original objectives of the meeting. Second, much of the meeting will inevitably be about quantifying the impact of changes correctly. Third, the accuracy and reliability of statements is suspect, can lead to an impairment of trust and lead to incorrect conclusions.
3. The most junior member of the presenting team or analyst most familiar with the underlying calculations is brought in, if not already at the meeting, and is asked to rerun the model during the meeting, running similar risks as 2 above. Additionally, the need to include an analyst in such a meeting can dilute the meeting's level of attendance and thereby impair a trusted advisor level dialogue.

We live in an app-enabled world. In our personal lives, these apps often allow us to change parameters through simplified graphic interfaces. The popularity of business intelligence visualizations (charts and graphs) also attests to the visual orientation of most professionals. Yet running analysis and calculations remains the purview of few analysts using counter-intuitive spreadsheets and other calculation engines, manipulating cells and algorithms in order to provide answers to business questions. No software is capable of visual, graphic control of calculations and data, or provide real time feedback on the impact of such changes, all within well-known and widely used presentation tools such as PowerPoint and others.

The proposed solution to these problems is an interactive data, calculation and visualization software hub that creates the foundation for true interactive presentations and real time scenario analysis within presentations by creating live, bidirectional connections between these data sources, calculation engines and visualizations. Further, by allowing visualizations to also be inputs, rather than just outputs, manipulation of calculations are made intuitive and accessible to a much broader segment of the population. A visualization, as used in this description, refers to a chart or graph, whereas a presentation tool refers to a host application (such as PowerPoint or Excel) that functions as the framework for the canvas or slides upon which the visualization can be placed. And an editable visualization is a visualization that contains elements whose position can be changed, thereby changing the value associated with that graphic element.

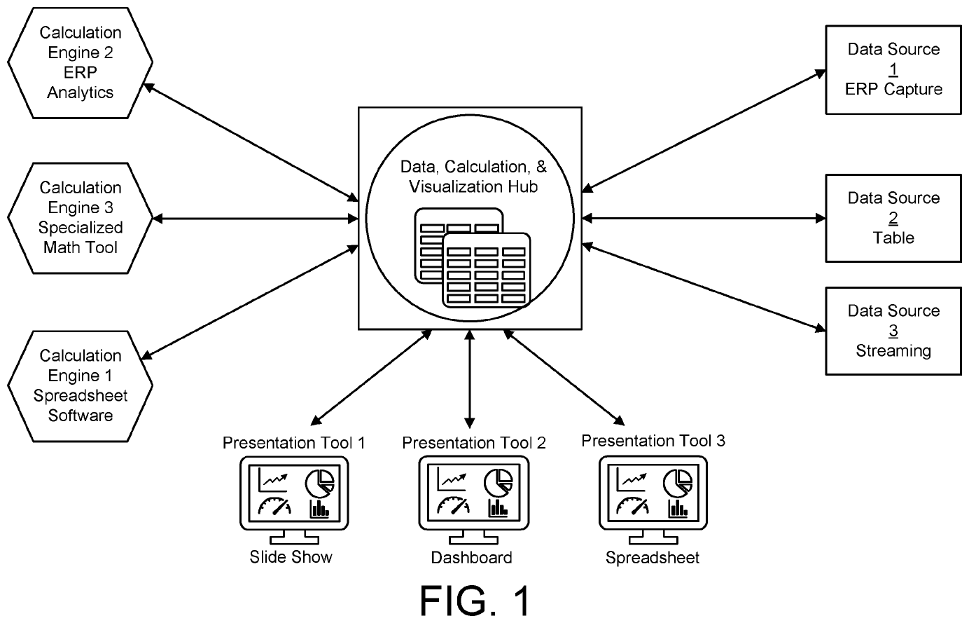

Referring to FIG. 1, the data, calculation, and visualization software hub in the circle in the center of the FIGURE is connected to any number of data sources, as illustrated in the square boxes on the right of the FIG. 1. This data, calculation and visualization software hub allows bidirectional synchronization of attached data sources, calculation engines and visualizations, which visualizations are placed within a presentation tool such as PowerPoint or Excel. Any change originating in any data source, calculation engine or visualization is immediately synchronized throughout the entire system, updating all of the other components of the system.

Examples illustrated as data sources might be for example Data source 1—Enterprise Resource Planning (ERP) capture. Other examples (Data Sources 2 and 3) could be tables of data, or streaming data.

The data, calculation, and visualization software hub is also connected to any number of calculations engines, as illustrated in the containers on the left-hand side of FIG. 1 such as Engine 1 (spreadsheet software), Engine 2 (Enterprise Resource Planning Analytics), or Engine 3 (Specialized Math Tools). Specialized Math Tools could be special tools provided to work in conjunction with the data, calculation, and visualization software hub. An example of a specialized math tool could be for example a Monte Carlo simulation module used to assess the range of possible outcomes of business cases. Some specialized Math Tools may require their own Calculation Engine, or many could be programmed with a spreadsheet software package such as Excel.

And finally, the data, calculation, and visualization Software Hub can be connected to any number of presentation tools as shown in the bottom portion of FIG. 1. These could include a slide show (such as PowerPoint), a dashboard, word processing software or spreadsheet presentation tools.

Regarding Enterprise Resource Planning (ERP), some organizations might already have an existing ERP system that system could be a source of data to the data, calculation, and visualization software hub on the one hand, and on the other, the ERP related analytical service could be joined to the Hub as a secondary (or primary for that matter) calculation engine.

Note that the software methodology proposed herein uses computer readable program codes recorded in a non-transitory computer readable memory.

### Summary Architecture

A defined data structure stores all data sources in defined data sets. Initial data from each data source is transferred into each defined data set and stored within the data, calculation, and visualization software hub. Each of these defined data sets is further tagged with additional meta data that indicates:
The designation of the data sources mapped to each defined data set;
The designation of whether each data source is changeable or non-changeable;
The designation of the calculation engine mapped to each defined data set;
A mapping of which vizualizations (charts and graphs) to which the defined data set must be projected, and if designated as an editable defined data set, which editable visualizations from which to receive data changes;
A designation of the mapping of the visualizations to the designated presentation tools in which they reside (slide shows, dashboards, spreadsheets).

Each change in the defined data sets, whether initiated by direct data input or by input into an editable visualization, then triggers:
A recalculation by the relevant calculation engine (as mapped in the metadata) and;
The results of the given calculation being written back into all defined data sets impacted by the change; and
A re-rendering of all visualization elements linked to the impacted data set(s) within the designated presentation tool in which the relevant visualization resides.

Likewise, each change within a given calculation engine, for instance a change of formula, then triggers:
A recalculation by the relevant calculation engine (as mapped in the metadata) and;
The results of the given calculation being written back into all defined data sets impacted by the change; and
A re-rendering of all visualization elements linked to the impacted data set(s) within the designated presentation tool in which the relevant visualization resides.

As shown in FIG. 1 data sources are outside of the data, calculation, and visualization Hub. Defined data sets are stored and acted upon in the data, calculation, and visualization Hub. Data source sets designated as changeable can have changed data written back into them or they can be designated non-changeable and retain their initial values. In this latter approach the changed data is saved in the data, calculation, and visualization Hub as another defined data set.

The data, calculation, and visualization software hub contains complete conflict resolution and persistence architecture that allows these processes to occur in real time, meaning a near immediate input-recalculation-output-update cycle.

### In Use

With the Active Data, Calculation and Visualization Hub in place, a number of in use possibilities exist. By way of example a typical use session can be described as follows:
1. When presenting or evaluating scenarios alone, the user of the Hub has, by definition, a linked calculation engine, data source and visualization/presentation tool.
2. These three elements are typically used separately, or possibly in serial combination, but in the case of the data, calculation and visualization Hub, these three elements are running in parallel and are synchronized in real time.
3. For simplicity, let us take an example in which the data in question is an Excel table, the calculation engine is Excel itself, and the visualization tool is PowerPoint. More specifically, the visualizations are graphs imbedded in PowerPoint slides together with standard presentation information.
4. Let us assume that the objective of the presentation/meeting is for senior management of a large corporation to discuss and agree the financial forecast for the following year.
5. Each of the income statement, balance sheet and cash flow are presented in tabular as well as line/bar chart format, including the actual results of the prior 5 years in sufficient detail to agree all major expenditure and investment proposals. All key drivers (market share, volumes, pricing for all products and capital expenditures, cost items) are clearly designated in the assumptions section of the underlying Excel workbook, and the presentation is also organized in this order.
6. Our presenter in the example is the CFO of the corporation, and the senior management is comprised of the heads of all major divisions, including front, middle and back office functions.
7. The CFO leads the discussion by presenting the base case forecast for all key drivers, and invites the other management members, especially those who are specialists or subject matter experts in the given underlying item, to validate the forecast or debate and agree alternative parameters for each. The setting of the parameters is executed simply and intuitively by the CFO using his touch enabled device (the screen of which is shared onto the projection screen): he simply drags the bar or line in the visualizations with his finger. Upon release of the element, the results of the entire model and associated presentation elements are recalculated and updated, including those graphs and linked text and data on slides not yet in view.
8. Upon any significant changes the CFO jumps straight to a summary key success factors and performance metrics slide, so that the impact of the given change in assumptions is immediately visible in both graphic and tabular form, as well as through any linked dynamic text.
9. Should the team wish to revisit any of the detailed assumptions or drivers, this process can be quickly and easily executed, and the resultant detailed and immediate “what-if analysis”, enables the team to optimize its plan. Further, several scenarios can be simulated and saved as versions with the touch of a button, and the CFO can also run Monte Carlo simulations on the proposed scenario to immediately assess the range of possible outcomes for which they are optimizing their forecast.
10. The CFO and management team can do this swiftly and with complete surety, as the underlying model, data and linkages to graphs were validated upon set up. Through using these connected graphs as inputs as well minimizes the chance of error arising from the editing of the cells and formulas of spreadsheets directly.

As should be evident, the in-use description given above is one of many possibilities and should not be taken as the only combination of steps that would be followed.

Although certain embodiments and their advantages have been described herein in detail, it should be understood that various changes, substitutions and alterations could be made without departing from the coverage as defined by the appended claims. Moreover, the potential applications of the disclosed techniques are not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include within their scope such processes, machines, manufactures, means, methods or steps.

We claim:

1. A computer implemented method for providing interactive two-way write back of data flows between visualizations, calculation engines, and data sources comprising:
a. an interactive data, calculation and visualization software hub with live bidirectional connections between the visualizations, data sources,
calculation engines, and presentation tools;
b. a data structure that stores all of the data sources in defined data sets within the data, calculation and visualization software hub;
c. whereas the interactive data, calculation and visualization software hub further comprises visualization elements (charts and graphs) that can write back changes in data to and from the defined data sets and the presentation tools;
d. wherein each defined data set is tagged with additional meta data;
said meta data comprising: designation of the data sources mapped to each defined data set; the designation of the calculation engines mapped to each defined data set; the designation of the vizualizations mapped to each defined data set, and the designation of the visualizations mapped to their designated presentation tools.
e. wherein any change in the defined data sets, whether triggered by direct data input or by an input into an editable visualization triggers a recalculation by the related calculation engines and writes back the results of the recalculation to all of the impacted defined data sets, and re-renders all of the visualization elements within the designated presentation tool in which the relevant visualization resides.

2. The computer implemented method for providing interactive two-way write back of data flows between visualizations, calculation engines, and data sources of claim 1 wherein any change entered into a given calculation engine triggers a recalculation by the related calculation engines and writes back the results of the recalculation to all of the impacted defined data sets, and re-renders all of the visualization elements within the designated presentation tool in which the relevant visualization resides.

3. The computer implemented method for providing interactive two-way write back of data flows between visualizations, calculation engines, and data sources of claim 1 further comprising use of additional meta data to designate which data sources may be changeable or non-changeable, and which visualizations may be editable or non-editable.

4. The computer implemented method for providing interactive two-way write back of data flows between visualizations, calculation engines, and data sources of claim 2 further comprising use of additional meta data to designate which data sources may be changeable or non-changeable, and which visualizations may be editable or non-editable.

5. The computer implemented method for providing interactive two-way write back of data flows between visualizations, calculation engines, and data sources of claim 3 wherein data sources designated as changeable will have the results of a recalculation by a related calculation engine written back not only to impacted defined data sets but to the changeable data source.

6. The computer implemented method for providing interactive two-way write back of data flows between visualizations, calculation engines, and data sources of claim 4 wherein data sources designated as changeable will have the results of a recalculation by a related calculation engine written back not only to impacted defined data sets but to the changeable data source.
